(19) United States
(12) Patent Application Publication
(10) Pub. No.: US 2012/0151005 A1
(43) Pub. Date: Jun. 14, 2012

(54) IMAGE FILE DOWNLOAD METHOD

(75) Inventors: Shu Gui Wu, Tianjin (CN); Chih Feng Chen, Taipei (TW)

(73) Assignee: INVENTEC CORPORATION, Taipei (TW)

(21) Appl. No.: 12/965,241

(22) Filed: Dec. 10, 2010

(51) Int. Cl. G06F 15/16

(52) U.S. Cl. 709/219

(57) ABSTRACT

A download method for image file includes the steps of reading a header of an image file from an image file server; reading a start data block in a plurality of disk data blocks of a target disk; when the start data block has progress information, obtaining a current data block according to the progress information; downloading an image file data block corresponding to the current data block from the plurality of image file data blocks of the image file to the current data block; updating the progress information; when the current data block completing download is an end data block of the target disk, downloading an image file data block corresponding to the start data block to the start data block, and updating partition table information of the target disk; and repeating the above steps till all the image file data blocks are downloaded to the disk data blocks.

### BACKGROUND OF THE INVENTION

1. Field of Invention

The present invention relates to an image file download method, and more particularly to an image file download method with the broken-point resume function.

2. Related Art

Before a computer, no matter a personal computer (PC), a large server, or a notebook computer, is provided to a user, an operating system may need to be installed for use by the user, or a navigation optical disk or a maintenance optical disk having an operating system may need to be provided to the user. Therefore, a computer manufacturer needs to install operating systems in computers in large quantities before shipping. Conventionally, first, an image file of an operating system which may be needed is configured in at least one image file server. A computer sends an image file download request to the image file server, and then the image file server responds and provides the image file needed by the computer.

However, in the process of downloading the image file, interruption of download is inevitable due to various accidents such as unexpected power outage, power off of the computer or image file server, system breakdown, or network cable off. An image file is generally stored based on a disk zone (or referred to as disk partition) of a computer and the file configuration. Therefore, in the process of downloading the image file, the data needs to be downloaded according to the order of the disk zones, and the data is correlated with each other in the whole download process. Due to the dependence of the later downloaded data on the previous data, upon interruption, the image file can only be re-downloaded from the beginning.

That is to say, in the conventional image file download method, once the download is interrupted, the computer has to perform download again from the beginning, regardless of the reason. Data that has been transmitted in the previous interrupted download process is abandoned, and the whole image file needs to be transmitted once again from the beginning.

Therefore, the conventional download method obviously has the problems of extreme waste of resources such as time and bandwidth, and low download efficiency in case of interruption. In addition, the file size of the image file is generally very large, which further intensifies the meaningless waste of the resources such as time and bandwidth.

### SUMMARY OF THE INVENTION

In order to solve the above problems, the present invention provides an image file download method, which is applicable for downloading an image file from an image file server to a target disk. The image file download method comprises: reading a header of the image file from the image file server; reading a start data block in a plurality of disk data blocks of the target disk that have the same size; obtaining a current data block according to a progress information, when the start data block has the progress information; downloading an image file data block corresponding to the current data block from the plurality of image file data blocks of the image file to the current data block, in which the image file data blocks are respectively corresponding to the disk data blocks; updating the progress information; downloading the image file data block corresponding to the start data block to the start data block and updating a partition table information of the target disk, when the current data block completing download is an end data block of the target disk; and repeating the above steps till all the image file data blocks are downloaded to the disk data blocks.

However, when the start data block does not have the progress information, the disk data block next to the start data block may be used as the current data block, and the progress information is created in the start data block. Before the step of reading a start data block in a plurality of disk data blocks of the target disk wherein the disk data blocks have the same size, the image file download method may further comprise: terminating the download of the image file when a disk capacity of the target disk is lower than an image file capacity of the image file.

The header may comprise an image file name, an image file size, a source disk size, a data block size, a data block quantity, or a plurality of image file data block addresses of the image file data blocks in the image file. The image file may comprise a disk data block index information, so as to record a plurality of index positions of the disk data blocks respectively corresponding to the image file data blocks. The image file may further comprise an end of file (EOF).

In addition, the progress information may comprise an index position of the current data block, a data block download table, and an authentication information of the image file or procedure parameter information. The image file data blocks may each comprise a metadata and a content data. Each of the metadata may comprise a data block marker, a data block size, or a compression flag of the image file data block that the metadata belongs to.

To sum up, the image file download method avoids the dependence of the data on each other, and maintains the progress information in the target disk, so as to achieve the broken-point resume function. Therefore, a target computer does not need to repeat previously downloaded data, thereby greatly improving the download efficiency. Moreover, information such as the authentication information of the image file is maintained in the progress information, such that consistency of the image file in resumption can be ensured.

These and other aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment, and wherein:

FIG. 1 is a schematic view of an image file according to an embodiment;

FIG. 2 is a schematic view of a target disk according to an embodiment; and

FIG. 3 is a flow chart of an image file download method according to an embodiment.

### DETAILED DESCRIPTION OF THE INVENTION

The detailed features and advantages of the present invention are described below in great detail through the following embodiments, the content of the detailed description is sufficient for those skilled in the art to understand the technical content of the present invention and to implement the present invention accordingly. Based upon the content of the specification, the claims, and the drawings, those skilled in the art can easily understand the relevant objectives and advantages of the present invention.

The present invention provides an image file download method, which is applicable for downloading an image file from an image file server to a target disk of a target computer.

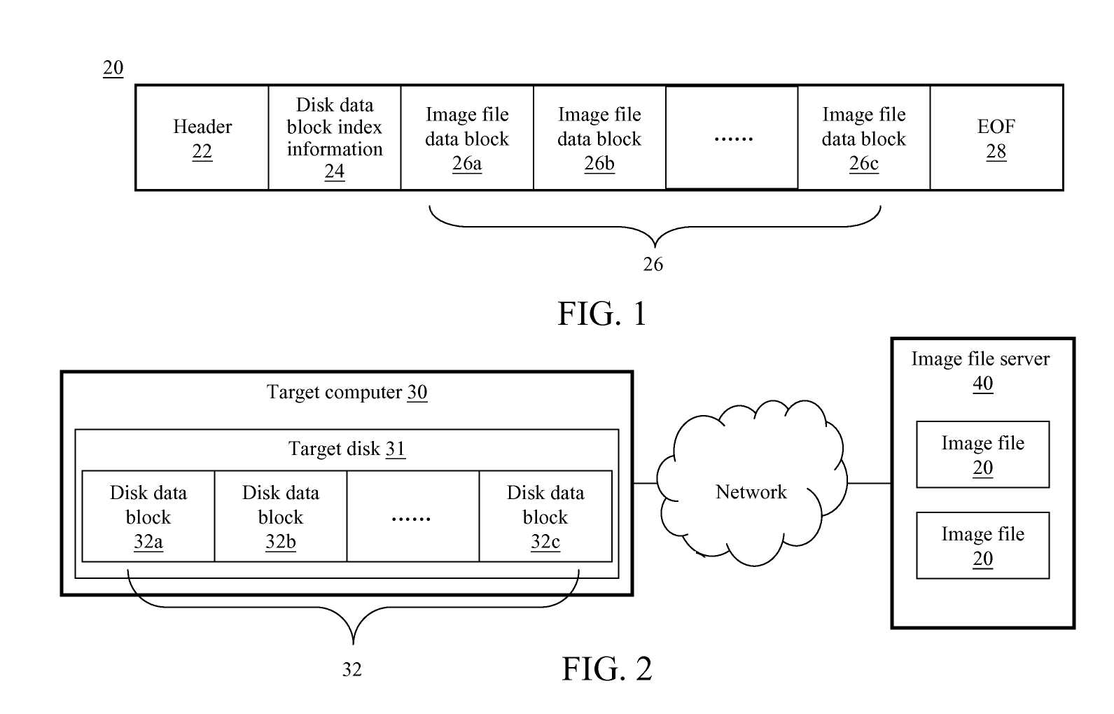

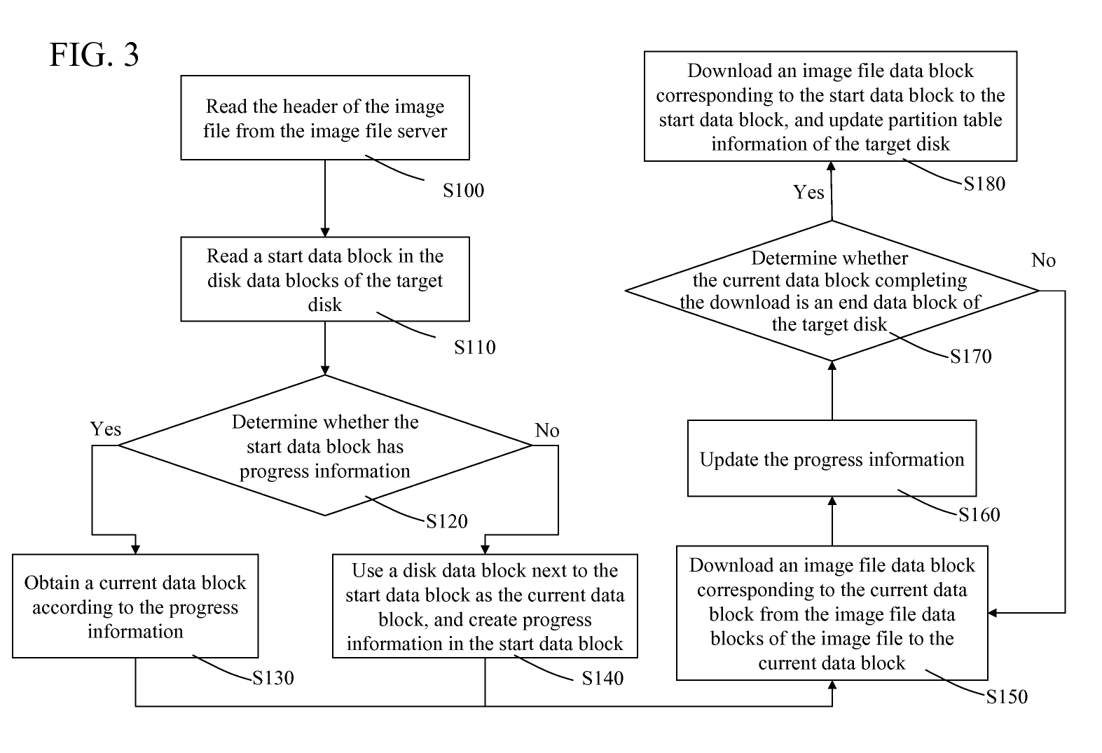

FIGS. 1 and 2 are respectively schematic views of an image file and a target disk according to an embodiment.

An image file 20 may be an International Organisation for Standardisation (ISO) 9660 file system (commonly referred to as an ISO file), or Windows Imaging (WIM) file type of Microsoft. The image file 20 may also be, for example, system files or kernel programs corresponding to various operating systems, for example, system files of Windows 7 system.

The image file 20 comprises at least one header 22 and a plurality of image file data blocks 26, in which the header 22 is used to record all information of the image file 20. The image file data blocks 26 have the same size, and are independent of each other. The header 22 may comprise an image file name, an image file size, a source disk size, a data block size, a data block quantity, or a plurality of image file data block addresses of the image file data blocks 26 in the image file 20.

The image file data blocks 26 may respectively comprise a metadata and a content data. Each of the metadata may comprise a data block marker, a data block size, or a compression flag of the image file data block 26 that the metadata belongs to. A first image file data block 26 of the image file 20 may comprise a disk partition table of a target disk 31. Moreover, the image file 20 may further comprise an EOF 28.

A target computer 30 may be a desktop computer, a notebook computer, a server, a personal digital assistant (PDA), or a smart phone. The target disk 31 may be, for example, various high-capacity hard disks, redundant array of inexpensive disk (RAID) systems, or hard disks built in portable devices. In addition to the target disk 31, the target computer 30 may further comprise a central processor unit (CPU) or other hardware such as a memory. Furthermore, the target computer 30 may be connected to an image file server 40 through a network, so as to download the image file 20 of the image file server 40.

The target disk 31 comprises a plurality of disk data blocks 32 for storing the downloaded image file data blocks 26, and thus the disk data blocks 32 are respectively corresponding to the image file data blocks 26. Taking the embodiment shown in FIG. 1 as an example, the disk data blocks 32a, 32b and 32c are respectively corresponding to the image file data blocks 26a, 26b and 26c. Therefore, these disk data blocks 32 have the same size as that of the image file data blocks 26. It should be noted that the target disk 31 may further comprise other disk data blocks 32 not for downloading the image file 20. However, for ease of illustration, only actions of the disk data blocks 32 involved in download of the image file 20 are described hereinafter.

First, the target computer 30 reads the header 22 of the image file 20 from the image file server 40 (Step S100); and determines whether the image file 20 is the desired one according to information such as the image file name or image file size recorded in the header 22. The target computer 30 reads a start data block in the disk data blocks 32 of the target disk 31 (Step S110), in which the start data block is the first block in the disk data blocks 32 used to download the image file 20. As for the embodiment shown in FIG. 2, the disk data block 32a is the start data block. In addition, the image file 20 may comprise a disk data block index information 24, so as to record a plurality of index positions of the disk data blocks 32 respectively corresponding to the image file data blocks 26. The target computer 30 can find desired addresses of the disk data blocks 32 in the target disk 31 according to the disk data block index information 24.

According to an embodiment, before Step S110, the image file download method may further comprise: terminating the download of the image file 20, when a disk capacity of the target disk 31 is lower than an image file capacity of the image file 20. That is to say, before really beginning to download the image file 20, whether the disk capacity of the target disk 31 is enough may be checked first, so as to avoid the dilemma that the download of the image file 20 cannot be completed in the course of download.

Then, it is determined whether the start data block has a progress information (Step S120). The progress information is used to record the download progress of the image file 20 in the target disk 31, if the download progress is found in the start data block, it indicates that part of the image file 20 is previously downloaded in the target disk 31. When the start data block has the progress information, a current data block is obtained according to the progress information (Step S130). That is to say, a broken-point where the previous download is interrupted is recorded in the progress information. However, when the start data block does not have the progress information, the disk data block 32 (32b) next to the start data block (i.e., the disk data block 32a) is used as the current data block, and the progress information is created in the start data block (Step S140).

The progress information may comprise the index position of the current data block, a data block download table, and an authentication information of the image file 20 or procedure parameter information. The data block download table may record the download conditions of all the disk data blocks 32 as a bit map. For example, 1 may be used to indicate that the disk data blocks 32 have completed the download; and 0 may be used to indicate that the disk data blocks 32 have not completed the download. The authentication information may be a checksum code or a Message-Digest Algorithm 5 code (MD5 code), so as to ensure the consistency of the image file 20 before and after broken-point resume. The procedure parameter information is used to record relevant parameters needed in download, for example, a procedure operation type, a device identifier (ID) of the target disk 31 to be operated, a full path name of a file path of the image file 20, or an extend parameter of a disk zone. The file path of the image file 20 may be a network path, or a local path in the image file server 40. All the above content of the progress information can be created in the start data block in download of the image file 20 by the target computer 30, so as to be used when the broken-point resume is needed.

After the current data block is obtained, the image file data block 26 corresponding to the current data block is downloaded from the image file data blocks 26 of the image file 20 to the current data block (Step S150). As a continuation of the above embodiment, the image data block 26b corresponding to the disk data block 32b is downloaded to the disk data block 32b. It should be noted that, as each disk data block 32 is independent of each other, and each image file data block 26 is downloaded and restored to an absolute position of the target disk 31, the download action of one disk data block 32 does not influence other disk data blocks 32.

When the download of the image file data block 26 corresponding to the current data block is successfully completed, the target computer 30 updates the progress information according to the current data block (Step S160). In this case, the disk data block 32 next to the original current data block is set as a new current data block. The target computer 30 determines whether the current data block completing the download (that is, the current data block before updating in Step S160) is an end data block of the target disk 31 (Step S170). The end data block is the last block of the disk data blocks 32 used to download the image file 20. As for the embodiment shown in FIG. 2, the disk data block 32c is the end data block.

When the current data block completing the download is the end data block of the target disk 31, the image file data block 26 corresponding to the start data block is downloaded to the start data block, and a partition table information of the target disk 31 is updated (Step S180). That is to say, the image file data block 26 corresponding to the start data block is the last image file data block 26 downloaded in the whole image file 20. In this case, the downloaded image file data block 26 will cover the originally written the progress information. Moreover, because each disk data block 32 is independent of each other, the target disk 31 can maintain the partition information table to record a relation between the disk data blocks 32 and at least one disk zone (also referred to as disk partition) of the target disk 31.

When the current data block completing the download is not the end data block, Steps S150, S160, and S170 may be repeated till all the image file data blocks 26 are downloaded to the corresponding disk data blocks 32.

To sum up, the image file download method partitions the image file and the target disk into data blocks having the same size and independent of each other, so as to avoid the dependence of the data on each other. The image file download method also maintains the progress information in the target disk, so as to record the download progress, thereby achieving the broken-point resume function. In this way, the target computer does not need to repeat previously downloaded data, such that resources such as download time and bandwidth are greatly saved, and the download efficiency is improved. Furthermore, information such as the authentication information of the image file is maintained in the progress information, which can ensure the consistency of the image file in resumption. Therefore, this method also can avoid the download of wrong data from different image files due to, for example, man-made errors, thereby ensuring the correctness and uniqueness of the downloaded data.

What is claimed is:

1. An image file download method, applicable for downloading an image file from an image file server to a target disk, the method comprising:
reading a header of the image file from the image file server;
reading a start data block in a plurality of disk data blocks of the target disk wherein the disk data blocks have the same size;
obtaining a current data block according to a progress information, when the start data block has the progress information;
downloading an image file data block corresponding to the current data block from the plurality of image file data blocks of the image file to the current data block, wherein the image file data blocks are respectively corresponding to the disk data blocks;
updating the progress information;
downloading the image file data block corresponding to the start data block to the start data block, and updating a partition table information of the target disk, when the current data block completing download is an end data block of the target disk; and
repeating the above steps till all the image file data blocks are downloaded to the disk data blocks.

2. The image file download method according to claim 1, further comprising:
using the disk data block next to the start data block as the current data block, and creating the progress information in the start data block, when the start data block does not have the progress information.

3. The image file download method according to claim 1, wherein before the step of reading a start data block in a plurality of disk data blocks of the target disk wherein the disk data blocks have the same size, the method further comprises:
terminating the download of the image file when a disk capacity of the target disk is lower than an image file capacity of the image file.

4. The image file download method according to claim 1, wherein the header comprises an image file name, an image file size, a source disk size, a data block size, a data block quantity, or a plurality of image file data block addresses of the image file data blocks in the image file.

5. The image file download method according to claim 1, wherein the image file comprises a disk data block index information, so as to record a plurality of index positions of the disk data blocks respectively corresponding to the image file data blocks.

6. The image file download method according to claim 1, wherein the progress information comprises an index position of the current data block, a data block download table, and an authentication information of the image file or procedure parameter information.

7. The image file download method according to claim 1, wherein the image file data blocks respectively comprise a metadata and a content data.

8. The image file download method according to claim 7, wherein each of the metadata comprises a data block marker, a data block size, or a compression flag of the image file data block that the metadata belongs to.

9. The image file download method according to claim 1, wherein the image file further comprises an end of file (EOF).
